(19) United States
(12) Patent Application Publication
(10) Pub. No.: US 2016/0224913 A1
(43) Pub. Date: Aug. 4, 2016

(54) PROACTIVE EMPLOYEE RETENTION THROUGH ENGAGEMENT INDICATOR

(71) Applicant: Infosys Limited, Bangalore (IN)

(72) Inventors: Satish Kannan, Bangalore (IN); Anirudhan Vasudevan, Bangalore (IN); Bhaskar Viswanathan, Bangalore (IN); Esaivanan Sudanthirakody, Thane (IN)

(21) Appl. No.: 15/013,742

(22) Filed: Feb. 2, 2016

(30) Foreign Application Priority Data
Feb. 3, 2015 (IN) 533/CHE/2015

(51) Int. Cl. G06Q 10/06

(52) U.S. Cl. CPC G06Q 10/0635

(57) ABSTRACT

A method of estimating an employee engagement indicator is described which comprises receiving engagement data and criticality data of an employee as input, through a user interface. This engagement data and criticality data of the employee are analyzed to categorize the employee based on engagement level and criticality level wherein the engagement level and criticality level is determined based on the analyzed engagement data and criticality data respectively Further performing a mapping of the categorized engagement levels onto categorized criticality levels helps to determine a risk level of the employee generating a notification over a computer network to another employee based on the mapping.

This application claims the benefit of Indian Patent Application Serial No. 533/CHE/2015 filed Feb. 3, 2015, which is hereby incorporated by reference in its entirety.

### FIELD

A system, method and non-transitory computer readable medium for estimating an employee engagement indicator.

### BACKGROUND

Employee engagement has become the most sought after concept of any business environment. The idea of employee engagement is derived from the concept that a company wants to create a mutually-beneficial long-term relationship with employees and by extension, customers, such that commitment, loyalty, and profitability can soar. As is often the case, an employer cannot manage it if the employer does not measure it.

Conventional methods for measuring employee engagement usually include conducting employee sentiment surveys. There can be large delays between drafting the survey, distributing the survey, gathering survey responses, analyzing the collected data, and presenting the results. Given the amount of effort required, employee engagement surveys are often only conducted annually. Further, translation of these surveys into actionable activities bringing about a favorable result in terms of employee engagement is often delayed and lose significance by the time they are effectually implemented.

Until recent past there were no structured mechanisms available to capture and manage the individual Employee Engagement levels. Microsoft excel was used to capture and decide the early warning signals of employees manually. Engagement levels were usually not captured and if captured, were not measured systematically.

The major drawbacks of the existing methodologies employed were:

Unstructured and manual process.

Inputs from managers were not available systematically.

Collation of huge employee data was difficult.

Increased data issues and mismatch in reporting.

Lack of historical data (engagement and criticality)

Lack of consolidated views/reports

Lack of ability to manage the data systematically

Several follow-ups for data updates manually

Lack of traceability of engagement level data when resource mobility across functions happens

Implementation scalability limitations

Not scalable to evolve into a business Risk management tool

Data is dynamic with movement of employees and managers and therefore leads to loss of critical information on Individual Employee Engagement.

Implementation of excel templates across projects and units and collating data is a humungous task and error prone.

This technology addresses proactive employee engagement and managing business risks for maintaining sustainable organization growth. It addresses the following key areas.

Improve interaction with employees and managers.

Proactively identify and meet employee aspirations.

Obtain Individual and Consolidated EEI.

Provides Umbrella view at Employee, Account and Business unit level.

Improve regular 1-on-1 interaction between managers and employees apart from the performance evaluation cycle.

Track EEI at Employee, Account and Business unit level.

Business Risk Management (Risk identification, Risk Analysis, Planning for Risk Responses)

Identify criticality of employees to prioritize and plan action items.

Tracks employee specific issues to closure.

Helps the business team to plan resource optimization

Identify action plans for key talents to improve EEI

Identify action plans for Business unit level to improve EEI

Improve employee retention.

### SUMMARY

According to an embodiment of this technology, a method of estimating an employee engagement indicator is described which comprises receiving engagement data and criticality data of an employee as input, through a user interface. This engagement data and criticality data of the employee are analyzed to categorize the employee based on engagement level and criticality level wherein the engagement level and criticality level is determined based on the analyzed engagement data and criticality data, respectively. Further performing a mapping of the categorized engagement levels onto categorized criticality levels helps to determine a risk level of the employee generating a notification over a computer network to another employee based on the mapping (205). The risk level thus determined is also analogous to the level of engagement of the employee within the organization and may also be termed as the Employee Engagement Indicator

One purpose of this technology is to understand the engagement levels of individual employees and proactively take steps to continuously improve engagement levels of employees, balance out criticality of employees, there-by facilitate proactive retention. Continuous improvement in retention at the Project, Account and Business Unit level, translating to reduced attrition rates is also a target.

Further to improve the interaction between the manager and team members, understand individual aspirations and expectations of employees, the Manager enters the engagement and criticality level in the EEI tool based on the interactions. It also aims to provide mechanism to monitor, review and track key action plans implemented at Project, Account and Business Unit level to ensure better retention and engagement levels. It also provides engagement field map overview to Delivery Managers. EEI tool is also intended to track and analyze the criticality level of an employee. The mapping of the engagement level and criticality level is then recorded in the tool to determine a risk level. Every employee is categorized and bucketed into one of the levels determined through the above analysis.

Another aspect of this technology is to track and analyze the trend in engagement levels at individual employee level and provide risk management and best practices to the senior management. This enables in planning for proactive engagement action plans.

### BRIEF DESCRIPTION OF THE DRAWINGS

The various embodiments of the invention will hereinafter be described in conjunction with the appended drawings, provided to illustrate, and not to limit, the invention, wherein like designations denote like elements, and in which:

FIG. 1 illustrates a system or engagement analysis computing device in which various embodiments of this technology may be practiced.

FIG. 2 illustrates a method of facilitating proactive employee retention according to one embodiment of this technology.

### DETAILED DESCRIPTION

While this technology is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternative falling within the spirit and the scope of the invention as defined by the appended claims.

The method steps have been represented, wherever appropriate, by conventional symbols in the drawings, showing only those specific details that are pertinent to understanding the embodiments of this technology so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a process, method that comprises a list of steps does not include only those steps but may include other steps not expressly listed or inherent to such process, method. Similarly, one or more elements in a system or apparatus proceeded by “comprises . . . a” does not, without more constraints, preclude the existence of other elements or additional elements in the system or apparatus.

The features of this technology are set forth with particularity in the appended claims. The invention itself, together with further features and attended advantages, will become apparent from consideration of the following detailed description, taken in conjunction with the accompanying drawings.

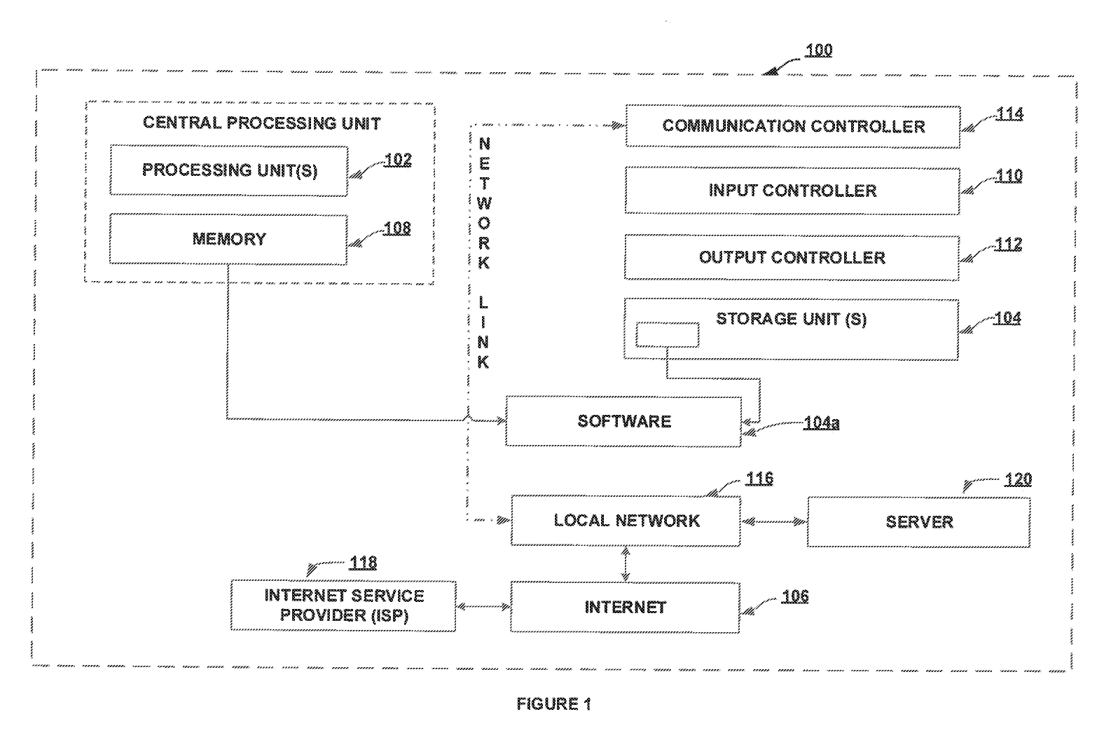

FIG. 1 is a block diagram of an engagement analysis computing device 100 to which this technology may be applied according to an embodiment. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not limited to an optical storage device, a magnetic storage device, a solid state storage device and a non-transitory storage device. The storage device 104 may contain software 104a which is a set of instructions (i.e. code). Alternatively, instructions may be stored in one or more remote storage devices, for example storage devices accessed over a network or the internet 106. The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110, output controller 112, and any other devices (e.g., network controllers, sound controllers, etc.). Output controller 112 may be operatively coupled (e.g., via a wired or wireless connection) to a display device (e.g., a monitor, television, mobile device screen, touch-display, etc.) in such a fashion that output controller 112 can transform the display on display device (e.g., in response to modules executed). Input controller 110 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network 116 and operated by an internet service provider (hereinafter referred to as ‘ISP’) 118 which provides data communication services to the internet. Network link typically provides data communication through one or more networks to other data devices. For example, network link may provide a connection through local network 116 to a host computer, to data equipment operated by an ISP 118. A server 120 may transmit a requested code for an application through internet 106, ISP 118, local network 116 and communication controller 114. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

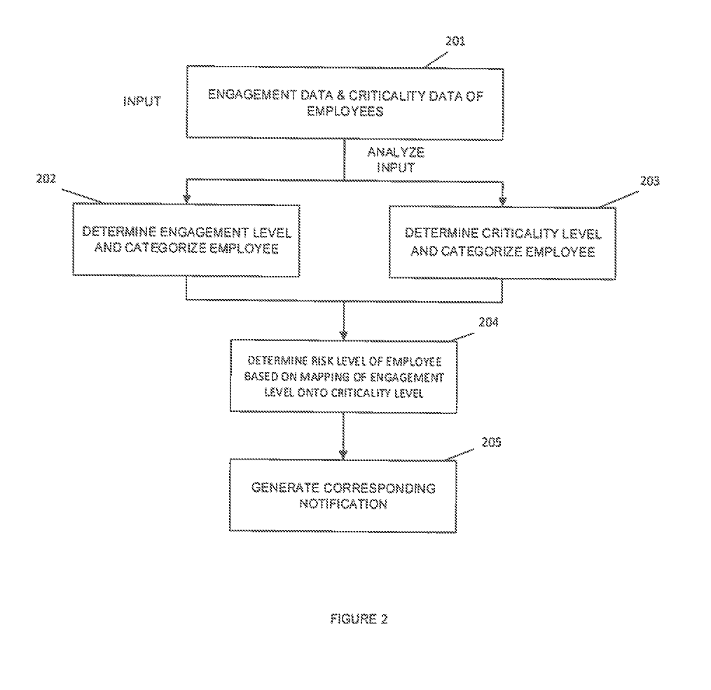

FIG. 2 is an embodiment of the method described and illustrated herein. The method comprises receiving an input (201) through a user interface. The input comprises engagement data and criticality data of at least one employee. The engagement data and criticality data for an employee is derived based on a one on one discussion with another employee in the organization who is hierarchically above the one for whom the data is being collected. Employee engagement data and criticality data may be collected, maintained, displayed, and/or stored in any suitable, known format. The employee engagement data may be stored in the memory (108). The collection of employee engagement data and criticality data may comprise multiple steps. In an exemplifying scenario, it may consist of a discussion of an employee under review with a hierarchically superior employee. The discussion may comprise evaluation based on multiple quantifiable parameters of engagement and criticality of the employee to an organization. The data thus obtained is quantified and recorded for use by the tool. The engagement data and criticality data received for an employee is analyzed using a processing unit (102) to determine an engagement level (202) and a criticality level (203) for each employee. This step “Categorization” emphasizes on a mandatory 1-on-1 discussion with the employees a team to understanding and quantize the behavioral parameters of each employee. The parameters are aimed at capturing a view of the aspirations and expectations of and from an employee. The parameters may be set in accordance with the policies and requirements of an organization and a mathematical value may be assigned to the parameters thus set. These parameters may be used as inputs and algebraic operators for the EEI tool to determine the engagement indicator as desired by the organization. Every employee is then categorized based using a processing unit (102) on each of the determined engagement level and the determined criticality level. An example of engagement levels and criticality levels for an organization is provided in table 1. These level nomenclatures may vary across organizations and across the industry.

TABLE 1

| Engagement Level | Criticality Level |
|---|---|
| Actively engaged | Highly critical |
| Passively engaged | Critical |
| Actively Disengaged | Less Critical |

Once each employee is categorized based on the Engagement level and Criticality level, a mapping of engagement level onto the criticality level is performed by the processing unit (102) so as to determine a risk level (204) that an employee would fall under. Subsequently, a notification is sent to another employee in the organization. This another employee should necessarily be hierarchically above in the organization from the one for whom this notification is being sent in the tool. The risk level thus determined is also analogous to the level of engagement of the employee within the organization and may also be termed as the Employee Engagement Indicator.

In an exemplifying embodiment of this technology the inputs recorded prior to the categorization of the employees, are updated through an input device in an Employee Engagement Indicator tool (hereinafter referred as EEI tool) provided through a user interface over a display terminal. The EEI too is a tool provided to stakeholders in an organization responsible for employee retention and risk mitigation related to impending attrition. The user interface for this tool provides for input and recording of data related to Engagement indicator for a set of employees over a period of time. It also provides for display of engagement level and criticality level of an employee. Further details related to the analyzed reasons for assigning an engagement level and a criticality need to be recorded in the tool for verification and validation. This ensures that an unbiased and verifiable set of data is recorded against each employee. In an exemplifying scenario, the data input by the manager is cross verified for correctness and validity by the senior management of a competent employee in the organization.

In another exemplifying embodiment, an engagement level and criticality level of the employee is determined based on the input provided by a manager of the employee. In one embodiment, an employee engagement survey is undertaken through a manager of an employee which comprises multiple items. One mode of undertaking the survey is through receiving inputs over a graphical user interface presented to the employees. The inputs may be received over a network or through a static form based document which is capable of recording user inputs through a digital input. The inputs may be received over any other means of data collection as may be feasible and available. The elements of engagement may be associated with dimensions. For example, the elements may be associated with one (or more) of six dimensions amongst Organizational Effectiveness, Recognition/Career Advancement, Supervision & Management, Co-Worker Performance/Cooperation, Higher Education and Personal Reasons. EEI tool utilizes both “measure” element and “operant” elements wherein measure element refer to whether or not the employee is actually engaged, while operant elements refer to whether the employee's operating job conditions would allow for improvement in his engagement.

For the sake of explanation and by example, the following elements may be considered “measures” of engagement, as these allow for an accurate determination of the employee's level of engagement (e.g., Actively Engaged, Passively Engaged, or Actively Disengaged): “Employees receive recognition for a job well done;” and “Employees here show an attitude of genuinely caring about the customer.” The following elements may be considered as “operant” of Engagement: “I am satisfied with my role in my job”, “My manager allows for optimal opportunities for career growth” and “Company policies are employee friendly and create a good environment for work”. A mathematical value may be assigned to each of the above to be used as operators for any algebraic operation that may be required to arrive at a corresponding value related to employee engagement indicator.

The elements of criticality may be associated with data collected describing attributes of the employees that can be accessed and compared against criticality criteria, conditions, and rules (sometimes referred to herein collectively as “rules”) to determine criticality ratings, scores, and scores of the employees. Criticality can represent an impact of one or more of the business environments being affected. In one embodiment, the criticality of an asset can be derived from a monetary value associated with and employee against a certain position held by him in a client engagement project, such as an estimate of the monetary cost of replacing the employee. Alternatively or additionally, the criticality of an employee can be derived from a business value of the employee, such as an importance of the employee to the overall project execution, delivery stream, etc. The criticality can also be based on the sensitivity and/or dependency of other employees on the particular employee and the potential effects of the particular employee absence. Ratings, scores, and other measures can be developed for the criticality of an employee. A measure of an employee's criticality can be considered in connection with risk assessments of the employee and the business environment as a whole. Risk assessment can include the assessment of the quantitative or qualitative value of risk related to a particular set of conditions or event affecting a particular employee.

Risk assessment is an important part of the EEI tool wherein employees are categorized and placed in the appropriate buckets in the Engagement Level vs. Criticality matrix, as depicted in Table 2 below

TABLE 2

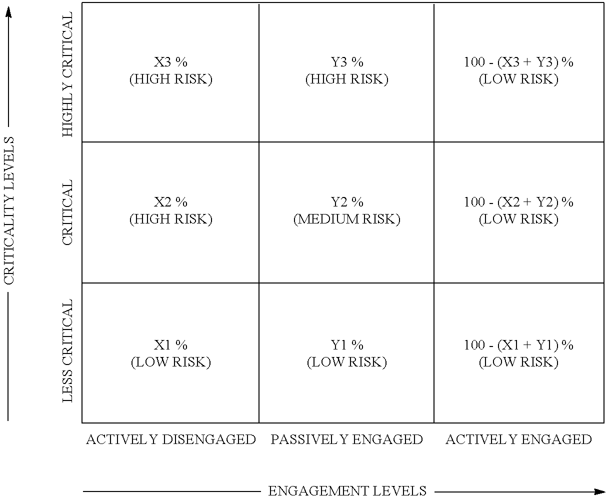

The categorization is done at the individual level and aggregated to the Project/program/business unit level to enable a consolidated view of the business risk due to key talents and plan responses accordingly. This matrix depicts the determined value of the employee to the organization and the risk of the employee leaving the organization for other opportunities. Talents in high risk category necessitate prioritized attention and talents in low risk categories may be because of previous proactive engagement initiatives, which could serve as best practices that can be replicated. The EEI tool may trigger alerts to the manager and the human resource department of a potential situation where key types of employees, such as those with sought after technical skills, are at risk of leaving the organization. This type of information may be further translated into action plans both at the HR level and the delivery level.

In an exemplifying embodiment, reports are generated by the HR and meets with the employees/delivery team based on the analysis and then action plans are laid out. HR team will mandatorily have one-on-one discussions with passively engaged and disengaged employees who fall under the high risk category. A collaborative exercise is undertaken in terms of sharing the ownership of action items based on the nature of action items. There are certain action items that the HR would own while certain action items will be owned by the delivery team (Project Mangers, senior project managers and Delivery Managers) to be implemented. These action plans are aimed at drawing the tabbed employee out of high risk zone by addressing the concerns which would have caused the risk. The action plan is rigorously monitored to ensure all activities and measures initiated to reduce the risk level associated with the employee are properly executed.

In another exemplifying embodiment of this technology, the EEI tool is configured to generate reports to facilitate the process of Employee Engagement indicator estimation. There are a variety of reports that the EEI tool may be configured to generate. EEI Tool may trigger regular updates and reports to Delivery Unit managers, Human Resources manager on Individual engagement levels of employees. This tool may also be configured to provide coverage on employees up to Delivery Manager. It provides exclusive report for Senior Project Manager, Group Project Managers and Delivery Managers that form part of the decision making chain of an organization. These reports enable to predict the EEI and assess the employee engagement risk to arrive at a proactive engagement action plans.

Engagement Level Vs. Criticality Report

One of the reports that may be generated using the EEI tool is the engagement level vs criticality report. This report provides a view of the engagement vs criticality level, at the project as well as program/portfolio/unit level. The report provides means to download the details for further analysis through a graphical user interface.

Predictability Index

One of the parameters used to arrive at the Employee Engagement Indicator or the risk level associated with each employee is the predictability index. Predictability index helps to determine the effectiveness of the predictions made by the managers in the employee engagement process based on the data available through the tool related to engagement levels and criticality levels. This parameter helps the managers to identify the improvement areas in assessing the employee engagement.

Having thus described the basic concept of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method of estimating employee engagement, comprising:
receiving as input, by an engagement analysis computing device and via a user interface, engagement data and criticality data for at least one employee;
analyzing, by the engagement analysis computing device, the engagement data of at least one employee to categorize the at least one employee based on at least one engagement level, wherein the at least one engagement level is determined based on the analyzed engagement data;
analyzing, by the engagement analysis computing device, the criticality data of at least one employee to categorize the at least one employee based on at least one criticality level, wherein the at least one criticality level is determined based on the analyzed criticality data;
mapping, by the engagement analysis computing device, the categorized engagement levels onto categorized criticality levels to determine a risk level of the at least one employee; and
generating, by the engagement analysis computing device, a notification over a computer network to at least one other employee based on the mapping.

2. The method of claim 1, wherein the engagement data and the criticality data of the at least one employee is determined based on an input received over the user interface by the at least one other employee.

3. The method of claim 2, wherein the at least one other employee is at a higher level in an organizational hierarchy.

4. The method of claim 2, wherein the received input is determined based on a set of parameters of employee engagement.

5. The method of claim 1, wherein the mapping is performed based on the categorization of the at least one employee to generate a data matrix view of criticality levels against engagement levels.

6. The method of claim 1, wherein a notification to the at least one other employee triggers a set of steps in an organizational process for bringing the at least one employee to a lower risk level.

7. A engagement analysis computing device comprising:
one or more processors; and
one or more memories operatively coupled to at least one of the one or more processors and comprising instructions stored thereon that, when executed by at least one of the one or more processors, cause the at least one of the one or more processors to:
receive as input, via a user interface, engagement data and criticality data for at least one employee;
analyze the engagement data of at least one employee to categorize the at least one employee based on at least one engagement level, wherein the at least one engagement level is determined based on the analyzed engagement data;
analyze the criticality data of at least one employee to categorize the at least one employee based on at least one criticality level, wherein the at least one criticality level is determined based on the analyzed criticality data;
map the categorized engagement levels onto categorized criticality levels to determine a risk level of the at least one employee; and
generate a notification over a computer network to at least one other employee based on the mapping.

8. The engagement analysis computing device as claimed in claim 7, wherein the engagement data and the criticality data of the at least one employee is determined based on an input received over the user interface by the at least one other employee.

9. The engagement analysis computing device as claimed in claim 8, wherein the at least one other employee is at a higher level in an organizational hierarchy.

10. The engagement analysis computing device as claimed in claim 8, wherein the received input is determined based on a set of parameters of employee engagement.

11. The engagement analysis computing device as claimed in claim 7, wherein the mapping is performed based on the categorization of the at least one employee to generate a data matrix view of criticality levels against engagement levels.

12. The engagement analysis computing device as claimed in claim 7, wherein a notification to the at least one other employee triggers a set of steps in an organizational process for bringing the at least one employee to a lower risk level.

13. At least one non-transitory computer-readable medium storing computer-readable instructions that, when executed by one or more computing devices, cause at least one of the one or more computing devices to:
receiving as input, via a user interface, engagement data and criticality data for at least one employee;
analyzing the engagement data of at least one employee to categorize the at least one employee based on at least one engagement level, wherein the at least one engagement level is determined based on the analyzed engagement data;
analyzing the criticality data of at least one employee to categorize the at least one employee based on at least one criticality level, wherein the at least one criticality level is determined based on the analyzed criticality data;
mapping the categorized engagement levels onto categorized criticality levels to determine a risk level of the at least one employee; and
generating a notification over a computer network to at least one other employee based on the mapping.

14. The at least one non-transitory computer readable medium of claim 13, wherein the engagement data and the criticality data of the at least one employee is determined based on an input received over the user interface by the at least one other employee.

15. The at least one non-transitory computer readable medium of claim 14, wherein the at least one other employee is at a higher level in an organizational hierarchy.

16. The at least one non-transitory computer readable medium of claim 14, wherein the received input is determined based on a set of parameters of employee engagement.

17. The at least one non-transitory computer readable medium of claim 13, wherein the mapping is performed based on the categorization of the at least one employee to generate a data matrix view of criticality levels against engagement levels.

18. The at least one non-transitory computer readable medium of claim 13, wherein a notification to the at least one other employee triggers a set of steps in an organizational process for bringing the at least one employee to a lower risk level.
